(19) United States
(12) Patent Application Publication
(10) Pub. No.: US 2019/0106119 A1
(43) Pub. Date: Apr. 11, 2019

(54) DRIVER ASSISTANCE CONTROL SYSTEM FOR A VEHICLE

(71) Applicant: VALEO Schalter und Sensoren GmbH, Bietigheim-Bissingen (DE)

(72) Inventors: Steve Kreyer, Bietigheim-Bissingen (DE); Malte Joos, Bietigheim-Bissingen (DE)

(73) Assignee: VALEO Schalter und Sensoren GmbH, Bietigheim-Bissingen (DE)

(21) Appl. No.: 16/156,385

(22) Filed: Oct. 10, 2018

(30) Foreign Application Priority Data
Oct. 11, 2017 (DE) 10 2017 123 581.7

(51) Int. Cl. B60W 50/08; G05B 15/02; H04L 29/08

(52) U.S. Cl. CPC B60W 50/08; H04L 12/28; H04L 67/12; G05B 15/02

(57) ABSTRACT

A driver assistance control system (10) for a vehicle, having a computer-based control unit (12) on the vehicle side to control at least one driver assistance function (26), and having a computer-based terminal device (16, 18) connectable via a network (20) to the computer-based control unit (12) using data transmission technology is disclosed. The computer-based terminal device (16, 18) includes at least one user interface (14) to display and/or operate the driver assistance function (26). The computer-based control unit (12) provides a WebSocket server (32) for a web application executable via the computer-based terminal device (16, 18), where the user interface (14) is implemented via the web application on the computer-based terminal device (16, 18). A corresponding data exchange is implemented using the JSON data format. A corresponding method to perform at least one driver assistance function (26) in a vehicle, and a corresponding computer program product is also disclosed.

The present invention relates to a driver assistance control system for a vehicle, having a computer-based control unit on the vehicle side to control at least one driver assistance function, and having a computer-based terminal device connectable via a network to the computer-based control unit using data transmission technology, wherein the computer-based terminal device comprises at least one user interface to display and/or operate the driver assistance function.

The invention furthermore relates to a corresponding method for performing at least one driver assistance function in a vehicle, and a corresponding computer program product.

Document DE 2012 007 984 A1 describes a driver assistance control system of this type for a vehicle, having a computer-based control unit on the vehicle side to control an automatic manoeuvring function and having a computer-based portable communication device connectable via a WLAN data connection to the computer-based control unit using data transmission technology, wherein the portable communication device comprises at least one actuation element to operate the automatic manoeuvring function. This actuation element provided by the terminal device is a user interface or a human-machine interface (HMI).

The two systems (a) computer-based control unit on the vehicle side and (b) user interface provided on the computer-based terminal device are often only very specifically programmable. The protocols for the data exchange between these two subsystems are furthermore often proprietary and non-standardized. Special expert knowledge is often required in order to extend these two subsystems. If a modification has to be made to a system function or if the system has to be extended with new system functions which relate to the operation or the display, a long TTM (Time-To-Market) must be expected. The proprietary HMI software is furthermore executable on this HMI hardware only.

On the basis of the aforementioned prior art, the object of the invention is therefore to indicate measures for performing at least one driver assistance function in a vehicle which enables modifications to the system or to the system function to be made relatively simply.

The object is achieved according to the invention by the features of the independent claims. Advantageous designs of the invention are indicated in the subclaims.

In the driver assistance control system for a vehicle according to the invention which has a computer-based control unit on the vehicle side to control at least one driver assistance function and a computer-based terminal device connectable via a network to the computer-based control unit using data transmission technology and which comprises at least one user interface to display and/or operate the driver assistance function, it is provided that the computer-based control unit provides a WebSocket server for a web application which is executable via the computer-based terminal device, wherein the user interface is implemented via the web application on the computer-based terminal device. The control unit is also referred to as the ECU (ECU: Electronic Control Unit). The web application is an application program according to the client-server model which is not installed locally on the terminal device of the user and is executed there. Instead, the data are processed and evaluated mainly on the control unit providing the corresponding WebSocket server. Only the result of the data processing is transmitted to the terminal device of the user for the display and operation of the driver assistance function.

Through this measure, the two subsystems (a) computer-based control unit on the vehicle side and (b) user interface provided on the computer-based terminal device are interlinked in a manner which is commonplace, at least for other applications.

According to one preferred design of the invention, at least one web client via which the web application is usable by a user is implemented on the computer-based terminal device. This web client is, in particular, a web browser and/or an operating and/or display app. The web application is used in many cases via a web page and a web browser. This web browser takes charge of the communication with the server via a corresponding protocol and the presentation of the user interface. Alternatively, the use of an app (app: application) as a web client is provided, in particular for mobile terminal devices.

The system is configured, in particular, for a data exchange between the computer-based control unit and the web client by means of the JSON data format. The JSON data format or data format in JSON (JavaScript Object Notation) is a compact data format in a relatively simply readable text form for the purpose of data exchange, in particular between applications such as web applications. The JSON data format is suitable in this context in particular because it is very simple and, in addition, it is also suitable for accessing the corresponding information from JavaScript code (which is executed by the web client in order to implement the HMI).

According to one further preferred design of the invention, it is provided that the terminal device is a computer-based mobile terminal device, in particular a Smartphone. For mobile terminal devices, the use of an app (app: application) as a web client is provided along with the use of a web browser. A tablet computer is a further possible mobile terminal device for the system.

Generally speaking, the driver assistance function may be one of the many functions of the driver assistance control system such as, for example, the adaptive cruise control function, braking assistance function, speed assistance function, lane-keeping assistance function, etc. According to another further preferred design of the invention, the driver assistance function is a parking assistance function.

According to one preferred design of the invention, the computer-based control unit is configured as a computer-based control unit integrated into an automotive context. An embedded system is an electronic computer (computer, computer-based device, etc.) which is integrated (embedded) into a technical concept. The computer either performs monitoring, control or regulating functions or is responsible for a form of data processing or signal processing, for example encryption, decryption, coding or decoding or filtering. The automotive context is normally a corresponding vehicle component of the vehicle.

According to a further preferred design of the invention, it is provided that the network is configured as a LAN or WAN. Whereas a LAN (Local Area Network) is a local network in which a plurality of computer-based devices communicate, for example in a household or in a company, internally via a network, a WAN (Wide Area Network) is an extensive network which consists, for example, of a plurality of LANs and is spread extensively, i.e. even across countries or continents. An Ethernet-based LAN (Local Area Network) or WAN (Wide Area Network) to which the web client and the server (the embedded ECU) are connected is preferably used for the system.

In the method according to the invention for carrying out at least one driver assistance function in a vehicle, having a computer-based control unit on the vehicle side to control the driver assistance function and having a computer-based terminal device connectable via a network to the computer-based control unit using data transmission technology, said terminal device comprising at least one user interface to display and/or operate the driver assistance function, it is provided that the computer-based control unit provides a WebSocket server for a web application which is executed via the computer-based terminal device, wherein the user interface is implemented via the web application on the computer-based terminal device. The method is carried out, in particular, by means of the aforementioned driver assistance control system for a vehicle.

According to one preferred embodiment of the invention, at least one web client, in particular a web browser and/or an operating and/or display app, via which the web application is used by a user, is implemented on the computer-based terminal device.

According to a further preferred embodiment of the invention, data are exchanged between the computer-based control unit and the web client by means of the JSON data format (JSON: JavaScript Object Notation).

In the computer program product according to the invention, it is provided that said computer program product comprises program parts which, when loaded onto a processor of a computer-based control unit, are configured to carry out the aforementioned method.

The invention is explained in detail below on the basis of a preferred example embodiment with reference to the attached drawing.

In the drawing:

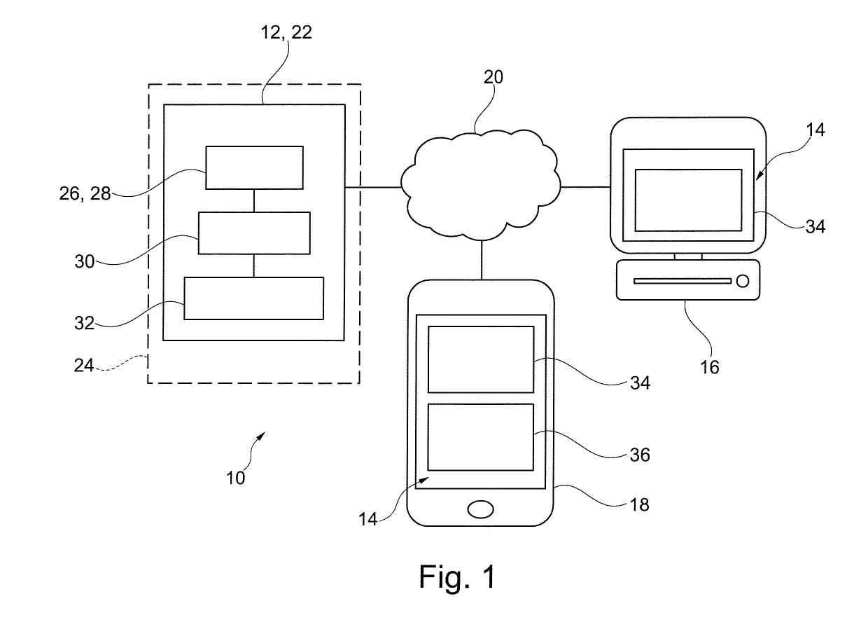

FIG. 1 shows a driver assistance control system for a motor vehicle according to one preferred embodiment of the invention.

FIG. 1 shows a driver assistance control system 10 for a motor vehicle (not shown) in a schematic representation. The system 10 comprises, as essential functional components, a control unit (ECU: Electronic Control Unit) 12 on the vehicle side and at least one user interface 14 which is provided by a computer-based terminal device 16 which, in particular, can also be configured as a mobile computer-based terminal device 18. The example shown in FIG. 1 presents instead a stationary computer-based terminal device 16, i.e. a PC (PC: Personal Computer), and a mobile computer-based terminal device 18, i.e. a Smartphone. The control unit 12 and the terminal devices 16, 18 are interconnected via a network 20 using data transmission technology. The control unit (ECU) 12 shown here is an embedded control unit (embedded ECU) which is integrated into a corresponding automotive context 24, normally a corresponding vehicle component of the vehicle. The control unit 12 provides a driver assistance function 26, in this case a parking assistance function 28, via its hardware and software components. In relation to the driver assistance control system 10, the control unit 12 forms a web server for a web application. Data are exchanged between the control unit 12 forming the server and the terminal devices 16, 18 forming the clients via data in the JSON data format 30. The control unit 12 furthermore also provides a WebSocket server 32 for the web application. The corresponding web clients 34, 36 are located on the terminal devices 16, 18. They are designed as a web browser 34 and an operating and/or display app 36. The user interfaces 14 are formed in the corresponding web client 34, 36, i.e., for example, a button clickable by means of a mouse click or a slide switch movable via a touchscreen in the browser 34.

The web application is an application program according to the client-server model which is not installed locally on the terminal devices 16, 18 of the user and is executed there.

Instead, the data are processed and evaluated mainly on the control unit 12, 22 providing the corresponding WebSocket server 32. Only the result of the data processing is transmitted to the terminal devices 16, 18 of the users for the display and operation of the driver assistance function.

Through this measure, the two subsystems (a) computer-based control unit 12 on the vehicle side and (b) user interface 14 provided on the computer-based terminal device 16, 18 are interlinked in a totally commonplace manner. In the system 10, data are therefore exchanged in the JSON data format between the computer-based control unit 12 and the web clients 34, 36. The JSON data format or data format in JSON (JavaScript Object Notation) is a compact data format in a relatively simply readable text form for the purpose of the data exchange, in particular between web applications. In addition, the JSON data format is also suitable for accessing the corresponding information from JavaScript Code which is executed by the web client in order to implement the HMI.

Characteristics and preferences of the shown system 10 are described once more below in other words.

The driver assistance control system 10 comprises:

an embedded ECU 22 with a driver assistance function 26, such as, for example, a parking assistance apparatus 28 which implements a server communication port based on WebSocket (RFC 6455) and TCP/IP (Transmission Control Protocol/Internet Protocol);

one or more web clients 34, 36 (e.g. a web browser 34 or Smartphone app 36) for the display and operation of the driver assistance function 26 via the user interface (HMI) 14;

a data exchange between the client (web client 34, 36) and the server (embedded) ECU 12, 22 via data 30 in the JSON (Java Script Object Notation) (RFC 7159) format;

a network 20 configured as an Ethernet-based LAN (Local Area Network) or WAN (Wide Area Network) to which the hardware of the web client 34, 36, i.e. the terminal devices 16, 18 and the control unit 12 (embedded ECU 22), are connected as a server.

The following advantages are gained:

The embedded ECU 22 implements a JSON interface which defines the corresponding data 30 for the display and operation of the parking assistance apparatus 28. This interface is made available via the WebSocket-based server communication port 32 to a web client 34, 36 connected via the network 20.

The use of these web technologies enables the driver assistance function 26 to be made available to each web-based client 16, 18. A user interface (HMI) 14 can thus be implemented as both a Smartphone app 36 and a website in each generic web browser 34. A user interface (HMI) 14 implemented as a website furthermore offers the advantage that it can be executed by any device 16, 18 which has an integrated web browser 34 (e.g. a Smartphone 18 or PC (Personal Computer) 16.

Due to the high degree of standardization of the communication technologies used, a user interface (HMI) 14 for the display and operation can be swiftly implemented. Modifications to a system function and new system functions relating to the display and operation can also be swiftly implemented and thus help to reduce the TTM accordingly.

FIG. 1 shows a possible set-up. The web browser 34 and app execution environments have already integrated the WebSocket (RFC 6455) and JSON (RFC 7159) standard. Applications such as web pages in combination with a browser 34 or apps 36 thus serve as a WebSocket client 34, 36 which can connect to a WebSocket server (implemented by the embedded ECU). The parking assistance apparatus 28, executed on the control unit (ECU) 12 remotely via a WAN/LAN access, can thus be operated and results of this driver assistance function can be presented on the Smartphone 18 or the PC 16.

### REFERENCE NUMBER LIST

Driver assistance control system 10
Control unit (ECU) 12
User interface (HMI) 14
Computer-based terminal device (PC) 16
Computer-based mobile terminal device 18
Network 20
Embedded control unit (ECU) 22
Automotive context 24
Driver assistance function 26
Parking assistance function 28
Data in the JSON data format 30
WebSocket server 32
Web browser 34
App, in particular mobile app 36

1. A driver assistance control system for a vehicle, comprising:
a computer-based control unit on the vehicle side to control at least one driver assistance function; and
a computer-based terminal device, connectable via a network to the computer-based control unit using data transmission technology, and comprising at least one user interface to display and/or operate the driver assistance function,
wherein the computer-based control unit provides a WebSocket server for a web application executable via the computer-based terminal device, and
wherein the user interface is implemented via the web application on the computer-based terminal device.

2. The system according to claim 1, wherein at least one web client selected from a web browser and/or an operating and/or display application, via which the web application is usable by a user, is implemented on the computer-based terminal device.

3. The system according to claim 2, wherein the system is configured for a data exchange of data in the JSON data format between the computer-based control unit and the web client.

4. The system according to claim 1, wherein the terminal device is a computer-based mobile terminal device.

5. The system according to claim 1, wherein the driver assistance function (26) is a parking assistance function (28).

6. The system according to claim 1, wherein the computer-based control unit is configured as a computer-based control unit integrated into an automotive context.

7. The system according to claim 1, wherein the network is configured as a LAN or WAN.

8. A method for performing at least one driver assistance function in a vehicle comprising”
controlling, using a computer-based control unit on the vehicle side, the driver assistance function;
connecting a computer-based terminal device, via a network, to the computer-based control unit using data transmission technology;
providing, by the computer-based control unit, a WebSocket server for a web application executed via the computer-based terminal device;
implementing at least one user interface via the web application on the computer-based terminal device; and
displaying and/or operating the driver assistance function on the at least one user interface.

9. The method according to claim 8, wherein at least one web client comprising a web browser and/or an operating or display application, via which the web application is used by a user, is implemented on the computer-based terminal device.

10. The method according to claim 9, wherein data are exchanged in the JSON data format between the computer-based control unit and the web client.

11. computer program product comprising program parts which, when loaded onto a processor of a computer-based control unit, are configured to carry out the method according to claim 8.
